(19) United States
(12) Patent Application Publication
(10) Pub. No.: US 2004/0111482 A1
(43) Pub. Date: Jun. 10, 2004

(54) Electronic device, method for routing an electronic message from an electronic device to an output unit, and computer program element

(76) Inventors: Daniela Bourges-Waldegg, Adliswil (CH); Yann Duponchel, Adliswil (CH); Marcel Graf, Kilchberg (CH); Michael Moser, Zurich (CH)

Correspondence Address: IBM, P.O. Box 218, Yorktown Heights, NY, 10598, US

(21) Appl. No.: 10/636,004

(22) Filed: Aug. 7, 2003

(30) Foreign Application Priority Data
Aug. 13, 2002 (EP) 02405689.7

(51) Int. Cl. G06F 15/16

(52) U.S. Cl. 709/207

(57) ABSTRACT

Described is a method for routing an electronic message from an electronic device to an output unit. Automatically controlled steps are comprised of determining at least one of several output units based on a result of a message classification process, and of initiating the message to be routed to the determined output unit for presenting the message to a user of the electronic device. Further there is described an electronic device, having interfaces for connecting output units to the device, and a control unit for controlling the routing of messages. The messages are determined to be presented to a user of the device via at least one of these output units. The control unit is configured for determining at least one of these output units for routing a message to based on a result of a message classification process, and for routing the message to that interface serving the determined output unit.

### TECHNICAL FIELD

The present invention relates to an electronic device, a method for routing an electronic message from an electronic device to an output unit, and to a computer program element.

### DESCRIPTION OF THE PRIOR ART

Prior art personal computers are usually operated with an input unit and an output unit. A conventional input unit may be a keyboard or a computer mouse. A conventional output unit may be a screen. Each input unit is connected to the personal computer via an interface. Each output unit is connected to the personal computer via some other interface. The screen can be an integral part of the personal computer as well as the keyboard and form together a portable laptop. However, input and/or output units can be physically separated form the personal computer and be linked to the latter via cable or wireless link.

Usually there is set a default input unit and a default output unit. These default units are addressed in a standard mode. A default input unit can be for example a keyboard and a default output unit can be a screen. Other available input and output units can be individually addressed by the user by giving adequate commands to the personal computer to switch from the default unit to another unit or to add another unit for input or output purposes. If for example a message should not only be shown on a laptop screen but also on a separate screen device when higher resolution or bigger screen size is appreciated, the user can address the screen device as additional output unit by changing appropriate settings and thus making a message be shown on that screen device solely or in addition to the laptop screen.

In particular mobile computing devices pose fundamental human/computer interaction problems due to their small size and their limited output capabilities. Portable electronic devices like Personal Digital Assistants (PDAs), cellular phones or laptops have output displays limited in size due to portability reasons and due to a small overall weight of the electronic device. A way of overcoming this problem is to offer different output devices to an electronic device's user and have him actively choose between different interaction modes. Meanwhile voice-based output units, graphical output units, etc. and combinations of them are introduced for mobile computing devices. These output units are not limited in a way that they have to be fixed to the electronic device or be integral part of it. For example, a public display can be used as output device for a PDA. A headphone might be another alternative to the PDA's integral display. Public displays or speakers serving such purposes are soon to be offered as a convenience service at miscellaneous locations, like in public phone-booths, hotel and airport lounges, etc.. These output units can be connected to the electronic device in a wire-bound or a wireless way.

Therefore, a mechanism is appreciated for managing the output of messages to a user of an electronic device.

### SUMMARY OF THE INVENTION

In accordance with the present invention, there is provided an electronic device that comprises interfaces for connecting output units to the device. Messages are determined to be presented to a user of the device via at least one of these output units. A control unit controls the routing of these messages. The control unit is configured for determining at least one of said output units for routing a message to based on a result of a message classification process, and for routing said message to that interface serving said determined output unit.

A connectable output unit is basically capable of presenting messages to the user of the electronic device. Such an output unit may basically have many different embodiments. The output unit can preferably comprise all possible kinds of graphical displays. Preferred embodiments of output units are displays integrated into the electronic device or displays as a separate physical unit—portable or stationary—or stationary displays at public or private locations offering display opportunities for everybody having preferably a portable electronic device that can interact with the display via a suitable interface. The output unit can preferably comprise voice based units like headphones or speakers. Again such a voice based output unit can be an integral part of the electronic device itself, or be a separate physical unit, or be a stationary unit at a public or private location offering access to anybody having technical capabilities to address the unit. An output unit can show output capabilities but is not necessarily limited to: Displays or speakers of mobile phones, PDA's or laptops can act as output units for other electronic devices.

An interface for connecting such an output unit with the electronic device can comprise all what is needed to make the linked components work together. This might comprise hardware to make a connection work, software, and protocols. Such a connection can be realized in a wireless or wire-bound manner. Bluetooth or wireless LAN are examples for such wireless interfaces covering the field of short range data communication and being applicable to the present invention. It is not necessary that every interface includes its own plug or output port. Many output units can be connected to the electronic device by means of only one port, if for example time multiplexing mechanisms are applied. Nevertheless, with regard to the invention, every available output unit is connected to the electronic device via its own interface, so an interface is regarded more as a functional unit than a hardware component.

The control unit of the electronic device can include a microcomputer with a software program, or hardware, or be embodied partly as hardware logic and partly as software, or be embodied else. The control unit automatically routes a message to an interface serving a determined output unit, whereas the determination of the output device is dependent on the result of a message classification process. This automatically performed classification process is not necessarily run on the electronic device. A message sent to the electronic device and to be presented to the device's user via an appropriate output unit might also have the result of a classification process attached or else incorporated, with the classification process already being performed elsewhere.

By automatically selecting an output unit and/or an corresponding output format according to the classification of the information that is to be rendered, the message is always sent to that particular output unit that is best suited for each situation. The choice of an appropriate output device is self-managed. For example, it is in particular advantageous not to have private or confidential information be rendered on output units where the information can be overheard or overseen by other people. For example, on one of the mentioned public displays casual passers-by could look over the shoulder of a user or if some confidential information was “spoken” via a loudspeaker, others in the room may also hear it.

In a preferred embodiment, the electronic device includes a stored look-up table with classification levels being allocated to output units. Based on this kind of mapping between information classification levels and preferred output units the electronic device determines for each classification level which output unit to use. So this look-up table helps to address a message to an output unit once the message is classified. Such a look-up table does not necessarily has to have a fixed table stored, but can also be embodied as a kind of a stored rule or algorithm, with a certain relationship between classification results and output units. Even a plurality of output units can be associated to one particular classification level indicating that more output units are considered to be suitable to present the classified message. In particular, the electronic device can include a transformer unit to perform appropriate transformations of the message—for example text to speech conversion—to provide a form of the message that matches the selected output unit where necessary.

In another preferred embodiment, the electronic unit comprises a classification unit for running the classification process for classifying to be output messages. In this embodiment it is appreciated that the electronic device itself has means to decide which output unit is the preferred one for a certain message. An electronic device including such a classification unit is autonomous in realizing its output policy.

In a particularly preferred example of an electronic device embodying the present invention, the classification process is configured for classifying a message on the basis of its content. Evaluating the content of a message can give valuable information on which message should be presented on what kind of output unit. Searching the message for keywords or key elements that correspond to different classification levels is preferred to classify the content of a message: Keywords could be for example technical keywords, keywords indicating confidential content, keywords indicating messages with high priority or keywords indicating special importance of the content of a message. Other keyword categories are possible and can be introduced where appropriate. Such keywords and the underlying classification can preferably be set by a user of the electronic device. An appropriate correlation between classes and output units can be for example that all messages with important content are only to be presented via headphones.

In another preferred embodiment of the present invention, the classification process is configured for classifying a message on the basis of the presentability of the message. Presentability of a message with regard to a an output unit indicates, that a first message might be suitable to be presented to the user on a certain output unit while another message might not. For example a word message including only a certain number of characters can be displayed on a small PDA display, while another message including high resolution graphics might not be appropriately presented on the small PDA display. The high resolution graphics might therefore be routed to a bigger remote display like a fifteen inch or wider range screen. Preferably the electronic device selects an appropriate output unit by classifying message according to its presentability, for example by identifying the bit/byte amount of a message and conclude from the size of a message to the presentability of this message.

Another preferred classification process is based on classifying a message dependent on its sender. Senders can be grouped for example into business contacts or private contacts. These two groups would represent two classes of senders. Then, each message is classified into one of these classes and transmitted to the correlated output unit. Messages from business partners could for example only be presented on integral output units of the electronic device like build-in graphic displays, whereas private messages could also be transferred to other external output units.

In another preferred embodiment, the classification process is configured for classifying a message on the basis of its confidentiality level. This embodiment is very advantageous since output units can be divided into classes concerning the level of privacy they offer when presenting messages. This embodiment is in particular advantageous in case the electronic device includes an e-mail reading application. When running such an e-mail reading application a list of e-mail subjects is presented to the user of the device. Let the electronic device be currently connected to two output devices, a screen and a headphone. Preferably, an e-mail classified as confidential is a message to be routed to the headphones and is spoken to the user rather than to be shown on the screen. Therefore, the output unit is changed from screen to headphones, and the output format changes from text to voice. If an e-mail is not classified as confidential, the message is routed to the screen and not to the headphones.

Classifying messages into different confidentiality classes can be performed by analyzing the content of the message, but also by evaluating a header, flag or other note attached to or incorporated in a message indicating one or more levels of confidentiality. Evaluating such kind of headers, flags or other notes is another advantageous embodiment for classifying messages.

It is noted that some or even all of the mentioned ways of classification can be executed in parallel or mixed such that an overall classification is achieved considering many classification aspects like confidentiality, importance and/or sender of a message.

In another advantageous embodiment of the present invention, the electronic device comprises an identification unit for identifying connected output units and for making said control unit determine only one or more of said identified output units to route messages to. Preferably the electronic device is capable of recognizing all connected output units. Operating systems supporting a so-called “Plug and Play” mode introduce such capability. Before routing a message to a particular output unit, the electronic device preferably has a description of all connected and active output units as well as the format they accept. This is to prevent routing messages to interfaces with no counterpart output unit at all or with no switched on counterpart unit. Further to identifying presently connected output units, it can be very advantageous to check their current availability. Availability in this context means readiness of an connected output unit to present messages on demand. This is to prevent routing messages to output units that are currently not available, for example due to handling jobs for other electronic devices.

Preferably the electronic device is a portable device. Cellular phones, PDA's or laptops are members of a portable device family and are favorable addressees for implementing the invention since these devices offer lots of opportunities to connect to different output units at different locations.

The present invention also extends to a method for routing an electronic message from an electronic device to an output unit, comprising automatically controlled steps of determining at least one of several output units based on a result of a message classification process, and initiating this message to be routed to the determined output unit for presenting this message to a user of the electronic device.

Preferably, the message is classified and the classification result is provided. The classification can be performed based on the content of a message, or on the presentability of its content, or on its sender, or on its level of confidentiality.

In a preferred embodiment, it is checked which output units are available. Then, a message can only be routed to one or more of these available output units.

The present invention also extends to a computer program product having computer readable program code, executable by a digital processing unit to perform a method as hereinbefore described.

Advantages of the method and its embodiments as well as advantages of the computer program element correspond to the advantages of the inventive device and its embodiments described above.

### BRIEF DESCRIPTION OF THE DRAWINGS

The invention and its embodiments will be more fully appreciated by reference to the following detailed description of presently preferred but nonetheless illustrative embodiments in accordance with the present invention when taken in conjunction with the accompanying drawings.

The figures are illustrating:

FIG. 1 a block diagram of an electronic device in accordance with the present invention, and

FIG. 2 a flow chart of a method for routing an electronic message to an output unit in accordance with the present invention.

### DETAILED DESCRIPTION OF THE INVENTION

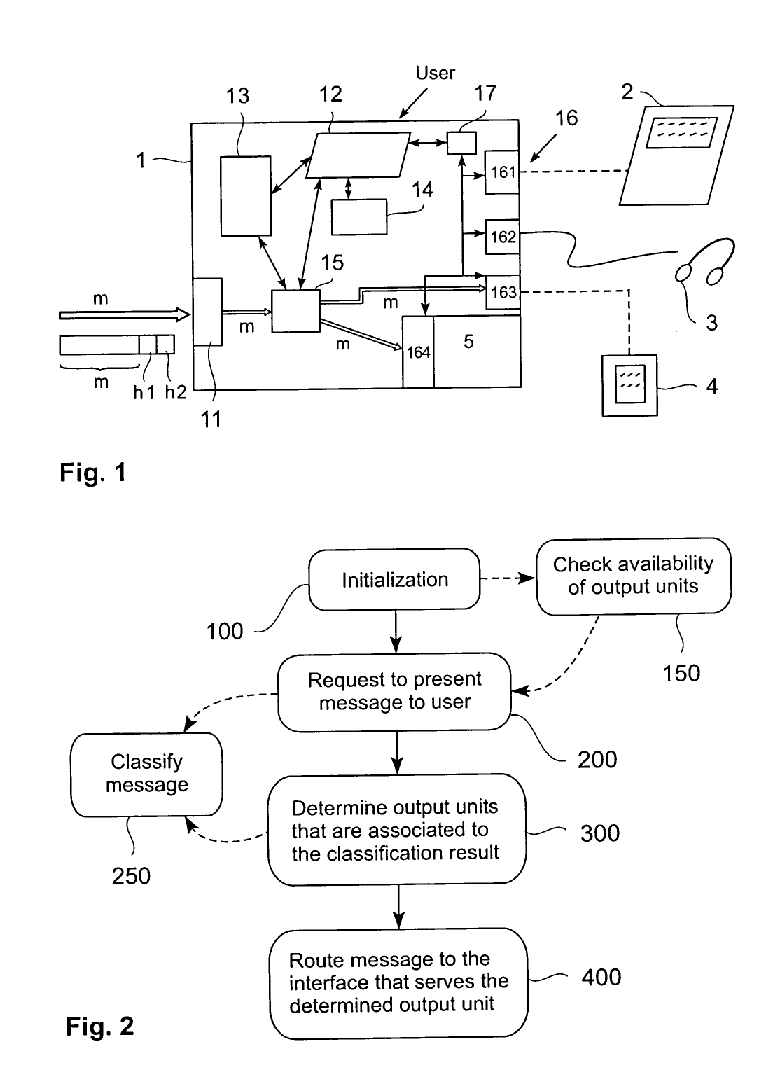

FIG. 1 shows a block diagram of an electronic device 1 in accordance with the present invention. The electronic device 1 is assumed to be a cellular phone but can be any other electronic device. Three symbolic output units are shown in FIG. 1 referenced by 2, 3 and 4. A public display 2 is connected to the electronic device 1, as well as headphones 3 and a PDA 4 (personal digital assistant). Dotted lines between the electronic device 1 and the output units 2, 3, 4 represent wireless connections, wherein the connection between the electronic device 1 and the public display 2 is a wireless LAN connection, and the connection between the electronic device 1 and the PDA 4 is an infrared connection. The straight line between the electronic device 1 and the headphones 3 is indicating a wire-bound connection.

Another output unit is referenced by number 5, which is representing the phone's integrated display.

Interfaces 16 are provided for the electronic device 1 to establish connections to output units 2 to 5. A wireless LAN interface 161 is addressing the public display 2, an audio interface 162 is provided for connecting the headphones 3 to the electronic device 1, and an infrared interface 163 is serving the connection with the PDA 4. Furthermore, a graphical card interface 164 establishes a connection to the display 5 of the cellular phone.

Furthermore, FIG. 1 shows an interface 11 for receiving messages. In this particular embodiment, the interface 11 is a regular GSM interface for transmitting and receiving voice and data signals to enable communication on the cellular phone. A message m received by the GSM interface 11 is shown symbolically. Attached to the message m is a header with parts h1 and h2, indicating a confidentiality level and indicating the sender of the message m. Such a message m can for example represent a SMS (Short Message Service).

The electronic device 1 further comprises a control unit 12, a classification unit 13, a look-up table 14, a data storage 15 and an identification unit 17.

The way the received message m is forwarded within the electronic device 1 is indicated by double line arrows. Single line arrows however indicate control procedures within the device 1.

First of all the received message m is stored in the data storage 15. Now, the user wants to have the received message m presented. Usually the user indicates this wish by setting a command via the phone's keyboard. In FIG. 1, the user's wish is indicated only as simple arrow labeled with the word “USER” for keeping FIG. 1 simple. This command is interpreted by the control unit 12. Hereupon, the control unit 12 takes different actions. One assumes that there is no “output”—advice added to the message m from the sender, so that device 1 has to perform classification steps to classify the received message m. The classification unit 13 is prepared to perform such classification, whereas header information as well as evaluation of the content of the message m is taken into consideration when defining a class for the message m. The classification unit 13 can be integrated into the control unit 12. In another embodiment, the classification unit is a piece of software being executed by the processor of the control unit 12.

After having calculated a classification result, the look-up table 14 gives information which output units 2, 3 or 4 are provided for presenting the message m to the user. According to this, the message m can be presented on the cellular phone's display 5 and on the PDA display 4 as indicated by double line arrows. The classification showed as exemplary result that the content of the message is confidential but not strictly confidential. The sender is rated as a private contact, and the size of the message is medium. The look-up table indicates for this classification result the routing of the message to the PDA display 4 and the phone's display 5. Due to the “confidential” rate, a presentation of the message m on the public screen 2 would not be appropriate. But the content of the message m is not rated strictly confidential, so an exclusive choice of the headphones is not appropriate either. Due to the medium size of the message m, an exclusive presentation of the message on the phone's display 5 might not be comfortable, so the PDA display 4 with the bigger display size is permitted to show the message m. Confidentiality is preserved by choosing the PDA display 4 as output unit.

The look-up table 14 is preferably stored in the device's storage 15 and only explicitly shown in FIG. 1 in favor of a better understanding of this embodiment of the invention.

The classification process can alternatively be performed as soon the message m is received. Here, the time to route the message to an appropriate output device is reduced once the user indicates that he wants to have the message presented. The classification result is then already stored and allocated to the message.

The identification unit 17 is configured for checking availability of output units connected to the interfaces 16. This check can be performed after initialization of the device or permanently by prompting the interfaces 16 continuously. The look-up table 14 is preferably updated with the latest availability status, so that the control unit 12 is permitted to initiate the routing of the message m only to available and active output units.

FIG. 2 shows a flow chart of a method for routing an electronic message to an output unit in accordance with an embodiment of the present invention. After initialization in step 100, an output request is received in step 200 to present a message to a user. In step 300, one or more output units are determined to route the message to. This determination is achieved by selecting the output units according to an output unit scheme that is associated to different levels of classification. Hence, the actual result of the classification determines the unblocked output units the message can or has to be routed to—see also step 400.

The classification step can be implemented and performed on the user's device or be implemented and performed elsewhere, for example on the device of the sender. This—at least for the electronic device—optional step is indicated by a dotted line incorporating a classification step 250.

Right after initialization, a check of availability of output units can be performed in step 150. The routing in step 400 can then rely on the result of the classification process in step 150 and on the result of the output availability check in step 150.

1. Electronic device, comprising
interfaces for connecting output units to said device,
a control unit for controlling the routing of messages, said messages being determined to be presented to a user of said device via at least one of said output units, said control unit being configured for:
determining at least one of said output units for routing a message to based on a result of a message classification process, and
routing said message to that interface serving said determined output unit.

2. The electronic device as recited in claim 1, further comprising a stored look-up table with classification levels being allocated to output units.

3. The electronic device as recited in claim 1, further comprising a classification unit for running said classification process for classifying to be output messages.

4. The electronic device as recited inclaim 1, wherein said classification process is configured for classifying a message on the basis of its content.

5. The electronic device as recited in claim 1, wherein said classification process is configured for classifying a message on the basis of its presentability.

6. The electronic device as recited in claim 1, wherein said classification process is configured for classifying a message on the basis of its sender.

7. The electronic device as recited in claim 1, wherein said classification process is configured for classifying a message on the basis of its confidentiality level.

8. The electronic device as recited in claim 1, comprising an identification unit for identifying connected output units and for making said control unit determine only one or more of said identified output units for routing a message to.

9. The electronic device as recited in claim 1, wherein said electronic device is a portable device.

10. A method for routing an electronic message from an electronic device to an output unit, comprising automatically controlled steps of:
determining at least one of several output units based on a result of a message classification process; and
initiating said message to be routed to said determined output unit for presenting said message to a user of said electronic device.

11. A method as recited in claim 10, wherein said message is classified and said classification result is provided.

12. A method as recited in claim 11, wherein said message is classified based on its content.

13. A method as recited in claim 11, wherein said message is classified based on its presentability.

14. A method as recited in claim 11, wherein said message is classified based on its sender.

15. A method as recited in claim 11, wherein said message is classified based on its confidentiality level.

16. A method as recited in claim 10, wherein the availability of output units is checked, and
wherein only one or more of the available output units can be determined for routing said message to.

17. A program storage device readable by a digital processing apparatus and having a program of instructions which are tangibly embodied on the storage device and which are executable by the processing apparatus to perform a method of routing an electronic message from an electronic device to at least one of a plurality of output units, said method comprising:
determining at least one of said output units based upon a message classification process;
and initiating said message to be routed to said determined output for presenting said message to a user of said electronic device.
